(19) United States
(12) Patent Application Publication
(10) Pub. No.: US 2014/0218497 A1
(43) Pub. Date: Aug. 7, 2014

(54) BIOMETRIC DATA ACQUISITION DEVICE

(71) Applicant: EYELOCK, INC., NEW YORK, NY (US)

(72) Inventors: Keith J. Hanna, New York, NY (US); Carlos A. Davila, Guaynabo, PR (US)

(73) Assignee: EYELOCK, INC., NEW YORK, NY (US)

(21) Appl. No.: 14/118,812

(22) PCT Filed: Jul. 9, 2009
(86) PCT No.: PCT/US2009/050117

§ 371 Date: Apr. 21, 2014

Related U.S. Application Data
(60) Provisional application No. 61/079,161, filed on Jul. 9, 2008.

(51) Int. Cl. G06K 9/00

(52) U.S. Cl. CPC G06K 9/00597
USPC 348/78

(57) ABSTRACT

An iris recognition system is disclosed wherein the tilt of a camera and illuminator module is manually or automatically adjusted in a manner that is efficient and easy to use, and wherein a user guidance system provides a reflective view of the user that facilitates user-centering. The camera and/or illuminator module are preferably tiltable only about a substantially horizontal axis. The user guidance system preferably includes a reflective surface that is convex in substantially only one direction, most preferably about a horizontal axis, and substantially flat about a vertical axis.

### RELATED APPLICATIONS

Priority is claimed from U.S. Provisional Patent Application No. 61/079,161, filed Jul. 9, 2008, entitled “Biometric Data Acquisition Device”, the teachings of which are incorporated by reference herein.

### BACKGROUND OF THE INVENTION

Biometric acquisition devices are responsible for acquiring image or other data that can be used in subsequent matching algorithms for the purposes of identity verification or recognition. Biometrics in common use are face, iris and fingerprint. The performance of biometric devices is often quantified solely by the false-accept, false-reject and failure-to-acquire rates. The iris biometric performs extremely well as quantified by these metrics [J G Daugman. High confidence visual recognition of persons by a test of statistical independence. IEEE Trans. on PAMI, 15(11):1148-1161, 1993]. Iris recognition algorithms and systems have been developed (e.g. U.S. Pat. No. 4,641,349, U.S. Pat. No. 5,291,560, U.S. Pat. No. 6,594,377) have been developed. On the other hand, the face biometric performs less well as quantified by the false-accept, false-reject and failure-to-acquire rates. This is because the appearance of the face varies widely in the presence of changes in illumination, pose of the user, facial expression, and appearance due to facial cosmetics or aging.

Notwithstanding this, for all practical applications, the performance of a biometric acquisition device and a subsequent matching algorithm needs to be quantified by multiple metrics, each of which may have more or less significance depending on the application. These metrics include: ease-of-use, size, cost, speed, reliability, compatibility with existing external systems.

Several approaches have been selected to perform acquisition of iris data. Hanna et. al in U.S. Pat. No. 6,714,665 describe a system whereby the iris is acquired using images reflected off a mirror mounted on a pan and tilt mechanism. One apparent benefit of this is that a user need not necessarily self-position themselves for capture, because the pan and tilt mechanism can locate the eye. However, when several users are in the vicinity of the device, then this apparent advantage becomes a significant disadvantage since neither the user nor the device is aware of which person's data has been or should be acquired. For example, in the case where a secondary action such as a user card-swipe or turnstile-actuation to permit user-access is required to be associated to a particular biometric acquisition, then it is important that biometric acquisition is not performed on just any arbitrary user that happens to be within the vicinity of the device.

A further disadvantage of the approach described by Hanna et. al in U.S. Pat. No. 6,714,665 is that the size and complexity of the pan and tilt mechanism increases the complexity, size and cost of the overall system while reducing reliability due to the number of moving parts.

Kim et al. in U.S. Pat. No. 6,594,377 describe an iris acquisition system shown in FIG. 1 which has an inner case 17 with a camera and illumination module 10 within an outer case 12, and where the inner case 17 pivots by means of a press of the hand 18 of the user 13 on the inner case 17. There are several problems with this approach.

First, since the outer case 12 surrounds the inner case 17, except the front surface 16 with the illumination and optics, the user 13 has to place their hand 18 on the front surface 16 to adjust the position of the system, as shown in FIG. 1. This means that the user has to rotate their shoulder substantially so that their arm is pointing directly in front of them, as shown by the small angle 14. This arm-motion and arm-position is unnatural and uncomfortable for many users, especially the elderly with limited shoulder cuff-rotation capability. For example, a report by the National Council on Compensation Insurance reports that rotator-cuff sprain is the 3^{rd} most reported worker-injury for those aged 65 and over. If the device is to be used several times per day by millions of users to gain access to buildings or mass-transit systems, then such a seemingly small consideration can become significant since even a very small percentage of incidents can result in thousands of affected users per day.

A second problem is that the hand 18 of the user is at or near the same front surface 16 where the optical surfaces of the camera and illumination modules 10 are located. There is therefore a strong likelihood that some or many users will inadvertently touch or graze those optical surfaces, leaving oil or other foreign material that reduces the quality of the images acquired and degrades the illumination, thereby degrading overall system performance.

A third problem is that the region where the left and right surfaces 19 of the inner case 17 and the left and right surfaces 12 of the static outer case meet is easily accessible by the hand 18 of the user 13.

Materials can be easily inserted into this region by a vandalistic user, thereby jamming the pivot mechanism and rendering it ineffective. In addition, since the surfaces 12 of the outer case substantially obscure the surfaces 19 of the inner case, it is non-intuitive for a user to move their hand to the inner surfaces 19 to adjust the angle of the inner case 17, resulting in confusion of the user.

A remaining problem is that the device must be capable of fitting in very compact locations, for example, between a door and a wall nearby that may be oriented in a direction perpendicular to the door, while at the same time maximizing the volume of the device to accommodate the required system components that will be described later. In addition, in many instances, biometric devices often have a requirement that the user stand in front of the device, as oppose to the left or right of the device. In the case of devices that have a width or extent comparable in size to the size of the user (more specifically, the average head width is approximately 6.1″ and the average shoulder width is 18.1″), then it is intuitive for the user to self-center perpendicular to the device, assuming that there is substantial symmetry of the device about a vertical axis through the center of the device. However, as the size of the device reduces with respect to the size of the user, then it becomes substantially less intuitive to the user that the requirement to stand in front of the device also corresponds to the requirement to stand perpendicular to the device.

### SUMMARY OF THE INVENTION

This invention describes a particular configuration of system housing, adjustable camera/lens and illuminator configuration, and user-guidance mechanism that address the problems described above. We describe a particular configuration of system housing, adjustable camera and illuminator configuration, and user-guidance mechanism in order to maximize system reliability and usability, while minimizing cost.

A first aspect of the invention is a biometric iris recognition device having primary housing pivotably attached to a base about a substantially horizontal axis. A first camera and a first illuminator module are both disposed in the primary housing and oriented to face a front of the primary housing. At least one handle, extending from and disposed off-center on an exterior of the primary housing, is adapted to allow a user to pivot the primary housing about the substantially horizontal axis to align the first camera and the first illuminator module with the user's eye.

Preferably, a hinge is formed between the primary housing and the base as the pivotable attachment, wherein the hinge allows the primary housing to rotate solely about the substantially horizontal axis. Optionally, the hinge further includes a position retaining mechanism; when a user sets an angular position of the primary housing with respect to the base, the angular position remains until another user affirmatively adjusts the angular position.

Preferably, the handle is disposed on a side portion of the primary housing substantially orthogonal to the front of the primary housing, and more preferably the at least one handle is offset from the substantially horizontal axis.

The primary housing can preferably rotate more than 90 degrees with respect to the base. In one version of the invention, the primary housing also a second camera and a second illuminator module. In this configuration, the first camera and illuminator module face in a first direction, and the second camera and illuminator module face in a substantially opposite rear direction.

A height to width ratio of the overall device is preferably substantially 2 to 1.

Preferably, the invention includes at least one positioning mirror disposed on the front of the primary housing, adapted to reflect the image of a user back to the user when the user's face is substantially aligned with the optical axis of the camera. The positioning mirror is preferably convex in primarily one direction only. In the case of the device with two sets of cameras and illuminators, the device has two such positioning mirrors, one for each camera/illuminator. In all cases, it is optimal for the positioning mirror to include an at least partially reflective surface that is convex about a substantially horizontal axis and substantially flat about a substantially vertical axis. Preferably, the first and/or second cameras each include a wide angle field of view in a substantially horizontal direction.

A second aspect of the invention is a biometric iris recognition device having a first camera and a first illuminator module both disposed in a primary housing and oriented to face a front of the primary housing. The camera may optionally be rotatably mounted in the primary housing about a substantially horizontal axis, or it may be fixed.

At least one first positioning mirror is provided, disposed on the front of the primary housing, adapted to reflect the image of a user back to the user when the user's face is substantially aligned with the optical axis of the first camera. The positioning mirror is convex in primarily one direction only.

Preferably, the primary housing is pivotably attached to a base about a substantially horizontal axis. As above, the primary housing may include a second camera and a second illuminator module, with the first camera and illuminator module facing in a first direction, and the second camera and illuminator module facing in a substantially opposite rear direction. As above, at least one second positioning mirror is disposed on the rear of the primary housing, adapted to reflect the image of a user back to the user when the user's face is substantially aligned with the optical axis of the second camera, wherein the second positioning mirror is convex in primarily one direction only. As above, the first and/or second positioning mirrors each include an at least partially reflective surface that is convex about a substantially horizontal axis and substantially flat about a substantially vertical axis.

The first and/or second positioning mirrors are optionally integral reflective portions of the primary housing. The primary housing may be one of a cylindrical, oval, or dome-like in shape.

A third aspect of the invention is a biometric iris recognition device having a primary housing attached to a base by means of a pivot that can only rotate solely about a substantially horizontal axis as above. An illuminator module is disposed in one of the primary housing or the base. A first camera module is disposed in the primary housing and oriented to face a front of the primary housing, the first camera including a wide angle field of view in a substantially horizontal direction. The device includes an automatic positioning means for pivotably positioning the primary housing about the substantially horizontal axis to automatically align an optical axis of the first camera with a face of a user. It is preferred that the camera's wide angle field of view is achieved by a field-widening mirror optically interposed between the first camera and a user. The field-widening mirror is convex in a substantially horizontal direction and substantially flat in a substantially vertical direction.

### BRIEF DESCRIPTION OF THE DRAWINGS

FIG. 1 is a top view of prior art.

FIG. 2 is a top view of the user bringing their hand towards the camera and illumination module in a first embodiment of the invention.

FIG. 3 is a top view of the user adjusting the tilt of the camera and illumination module in the first embodiment of the invention.

FIG. 4 is a top view of the first embodiment of the invention being rotated from one direction to another direction

FIG. 5 is a top view of the first embodiment of the invention where 2 camera and illumination modules substantially face an entry direction and an exit direction respectively.

FIG. 6 is a perspective view of a first embodiment of the system mounted on a wall.

FIG. 7 is a profile view of a first embodiment of the system mounted on a wall.

FIG. 8 is a perspective view of a first embodiment of the system mounted on a counter-top.

FIG. 9 is a block diagram of the system components in the invention.

FIG. 10 is a schematic view of a second embodiment of the invention.

FIG. 11 is a profile view of the second embodiment.

FIG. 12 is a perspective view of a further embodiment of the invention.

FIG. 13 is a perspective view of a further embodiment of the invention.

FIG. 14 is a schematic view of an embodiment of the invention being used to control a turnstile.

FIG. 15 is a schematic view of an embodiment of the invention being used to control a turnstile, with the addition of motion detectors.

FIG. 16 is a flow chart related to the two-way turnstile embodiment of the invention.

FIG. 17 is a schematic view of cameras and illuminators positioned within a housing, with mirrors to allow the same camera to provide a wide field of view and a narrow field of view.

FIG. 18 is a schematic view of an eye finding process of the invention.

FIG. 19 is a view of a person looking to the side.

FIG. 20 illustrates wide and narrow focused views of a person.

FIG. 21 is a flow chart of a process of one embodiment of the invention.

FIG. 22 is a schematic showing how one embodiment of the system provides a user interface for subjects of different subject heights.

FIG. 23 is a schematic showing a reflected view of a user of a first height.

FIG. 24 is a schematic showing a reflected view of a user of a second height.

FIG. 25 illustrates a device with a convex surface.

FIG. 26 illustrates a top and profile view of an embodiment of the invention.

FIG. 27 illustrates a top and profile view of an embodiment of the invention.

FIG. 28 illustrates a top and profile view of an embodiment of the invention.

FIG. 29 illustrates the use of piecewise convex reflective surfaces arranged adjacent to each other on a curved surface.

### DETAILED DESCRIPTION OF THE INVENTION

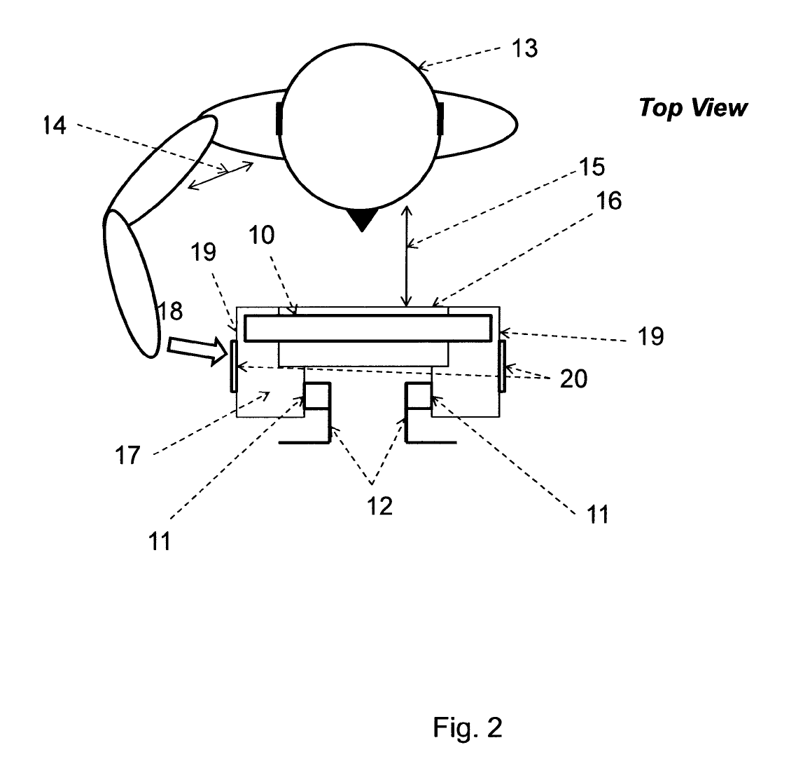

FIG. 2 shows a first embodiment of the invention. A first assembly 17 contains a camera and illuminator module 10 and is located on horizontal pivots 11, such that the left and right sides 19 of the first assembly 17 are freely exposed to the hand 18 of the user 13 for manual up-down adjustment. More specifically, a camera and illuminator module 10 is mounted in a first assembly 17 pointed substantially at a user 13 through a front surface 16, and a pivot mechanism 11 is mounted on a second assembly for pivoting the first assembly such that one or more side surfaces 19 of the first assembly are not enclosed by the one or more sides 12 of the second assembly.

In this embodiment, the first assembly 17 surrounds the pivots 11 as shown in FIG. 2.

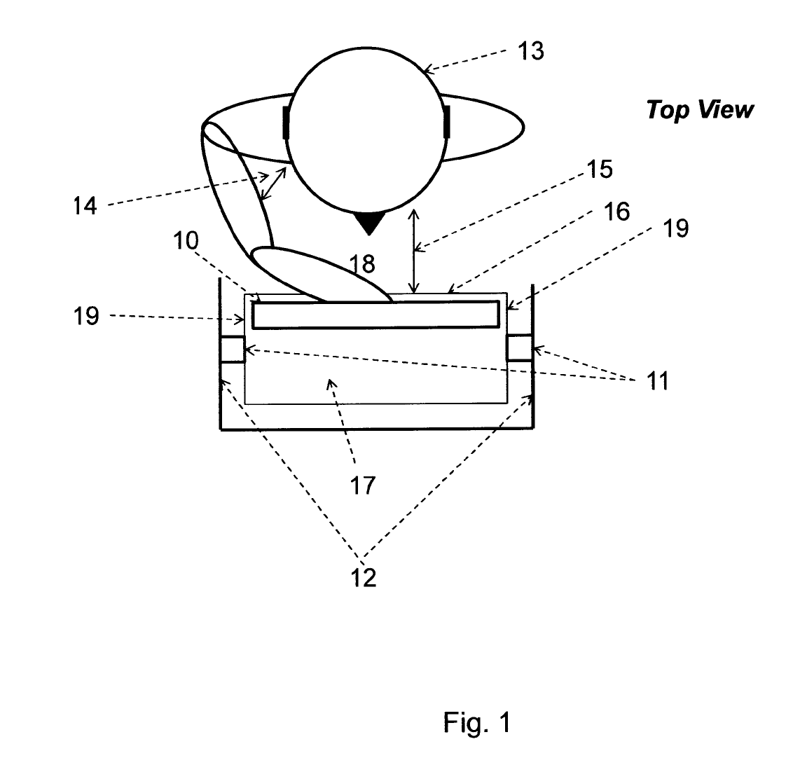

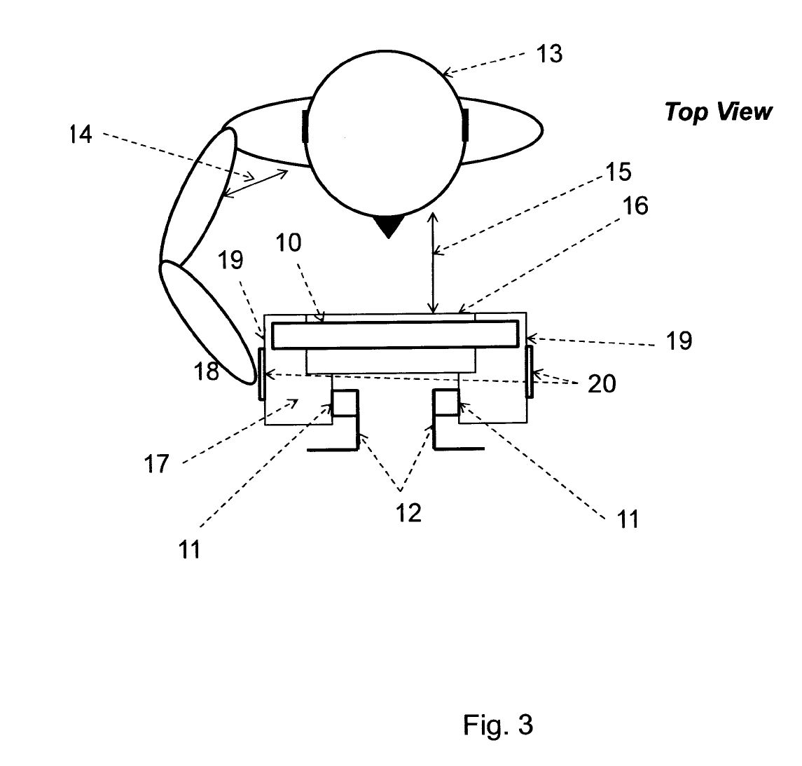

The first advantage of this mechanical configuration of the camera and illuminator module is that the user 13 can move their hand 18 from a wide angle from either the left or right, depending on whether the user adjusts the device with their left or right hand respectively, as shown in FIG. 2, and place their hand at a comfortable adjustment location 20 on the side of the device as shown in FIG. 3. This arm-motion and arm-position is much more natural and more comfortable for the user, as shown by the larger angle 14 between the torso and the arm as shown in FIGS. 2 and 3 compared to the smaller angle 14 in FIG. 1 where the user has to strain to move their arm closer to the center of the device.

The second advantage is that the hand 18 of the user is on a side surface 19 that is different to the optical surface 16 through which the camera(s) and illuminator(s) receive and transmit light. Even if the user fumbles with the surface 19 on the side while reaching for the adjustment paddle 20, they are much less likely to contaminate the front surface 16 with oil or other foreign material. The small hand-push paddles 20 are mounted on the sides 19 of the unit to encourage the user further to move their hand to the side of the unit, as shown in FIGS. 2 and 3. While it is possible to put a single knob or hand grip on the side 19 of the unit near the axis of rotation of the device, this is not preferred since due to the lack of leverage distance, the user needs to grip the knob tightly and apply more torque compared to a paddle or hand grip further from the axis of rotation of the device. This is because it is difficult for some elderly users or children to grip the knob tightly or apply sufficient torque.

A third advantage is that because the user does not need to rotate their arm so much towards the center of the device and their arm can now be more outstretched in front of them, then the perpendicular distance 15 of the user from the device can be larger therefore making the experience of using the device more comfortable for the user. For example, the perpendicular distance 15 from the device to the user in the embodiment in FIG. 2 and FIG. 3 is larger than the perpendicular distance 15 in FIG. 1, for the same arm-length.

A fourth advantage is that the first assembly 17 can potentially surround the pivots 11, protecting it from ice, dirt or other foreign materials that could jam the rotating mechanism, and its inaccessibility makes it more difficult for users to jam the mechanism by inserting objects between the first assembly 17 and the second assembly 12.

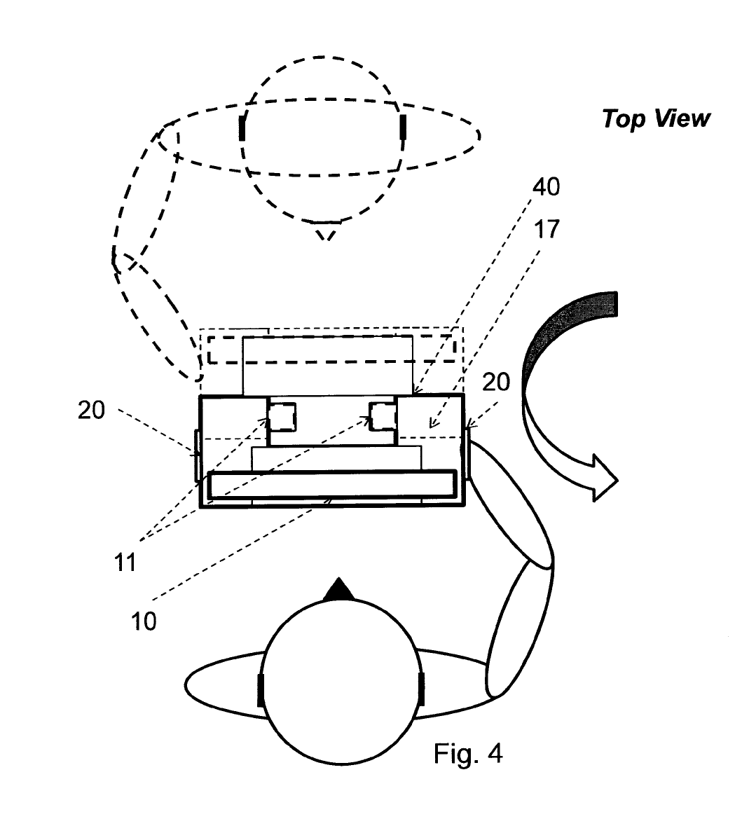

A fifth advantage shown in FIG. 4 is that the back 40 of the first assembly 17 that contains the camera and illuminator module 10 is not surrounded by the second assembly containing the pivot mount, such that the first assembly 17 can be rotated completely so that it is facing in almost the opposite direction. This allows entry and exit access control at a two-way turnstile or gate, for example, to be controlled by a single biometric device, thereby reducing cost and space requirements at a location where the availability of space is at a minimum. A typical minimum rotation from one direction to the next is one quarter to one third of a revolution, corresponding to 90 to 120 degrees.

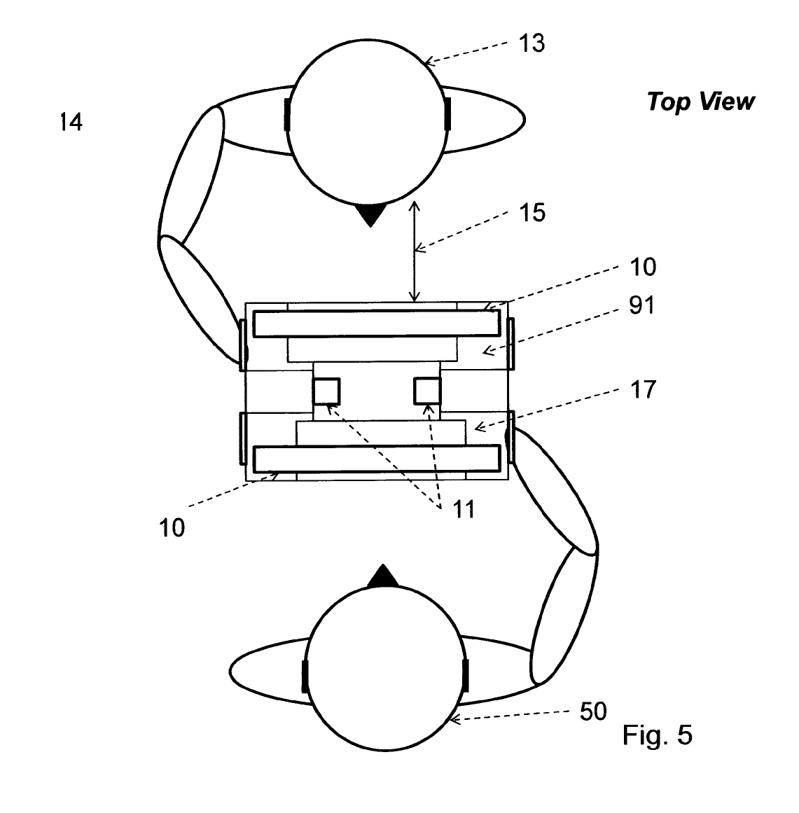

A second aspect of the first embodiment, shown in FIG. 5, is to mount 2 assemblies 17 and 91 containing separate camera and illuminator modules on the same pivot 11, with one module facing in one direction and the other facing substantially in the opposite direction. This also allows both entry and exit of a two-way turnstile or gate to be controlled by a single biometric device, with the added advantage that the rotation of the unit required to change operation from one direction to the next is negligible for an entering user 13 or an exiting user 50. A single Control and Image Processing Module 91 and Illuminator Control Module 93 can control the each of the Camera modules 90 and Illuminator Modules 92 facing in either direction, as described later. This reduces space and cost.

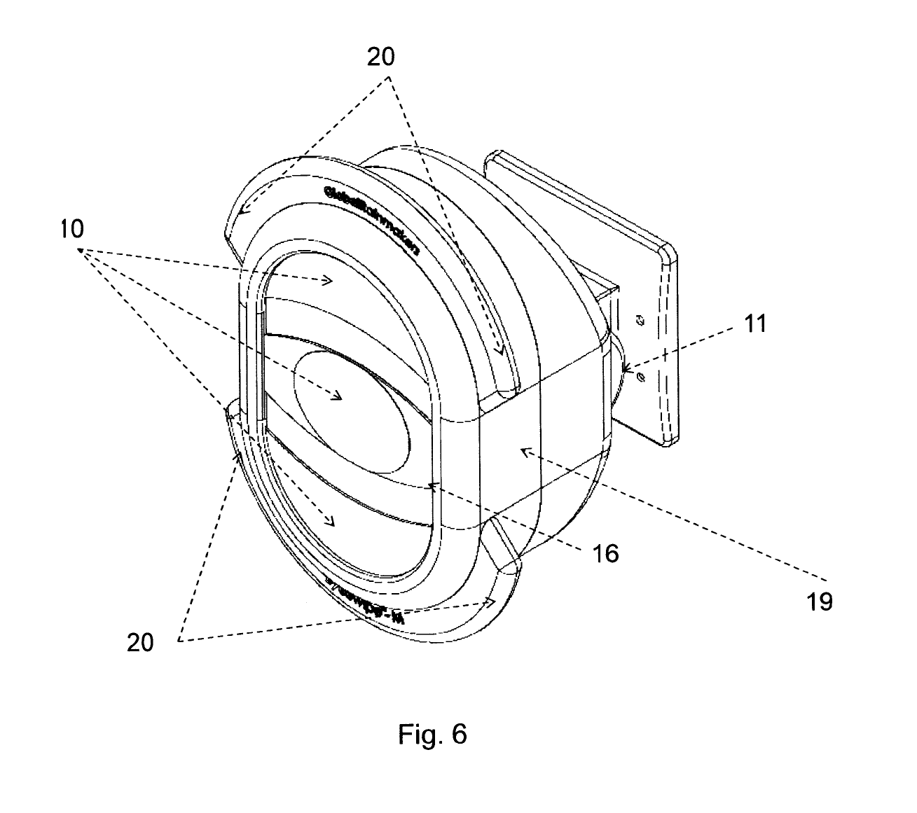

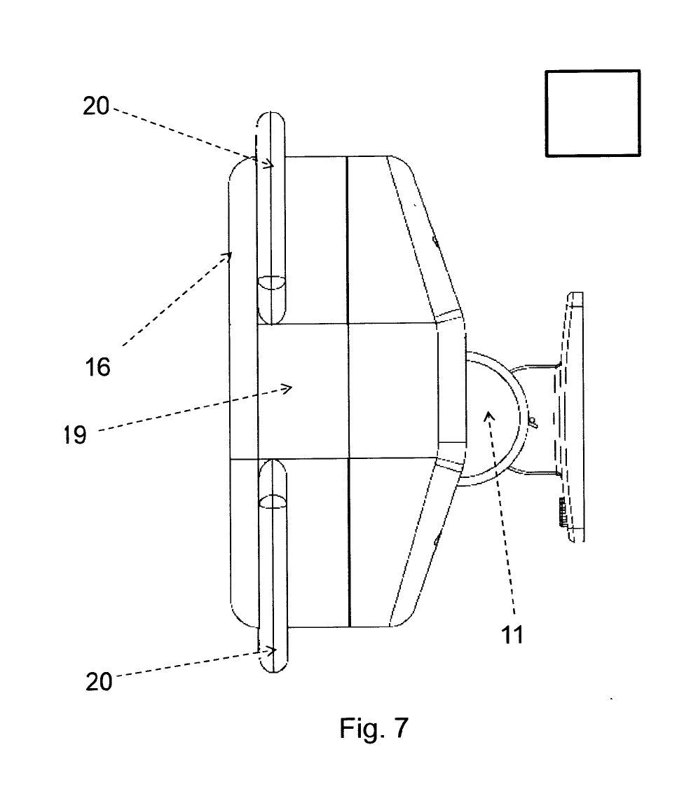

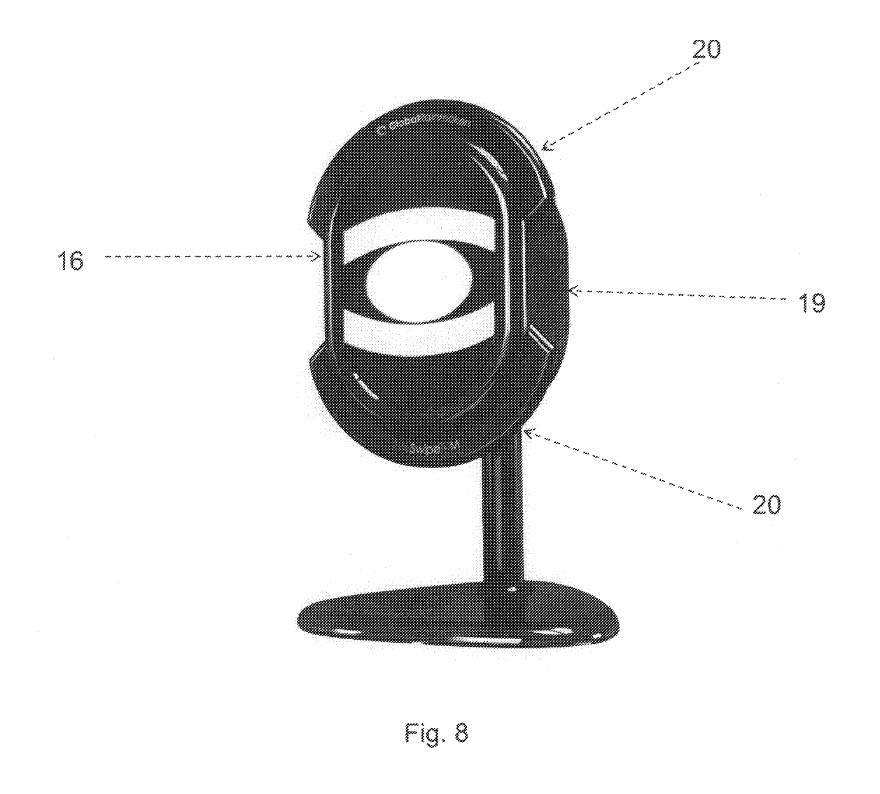

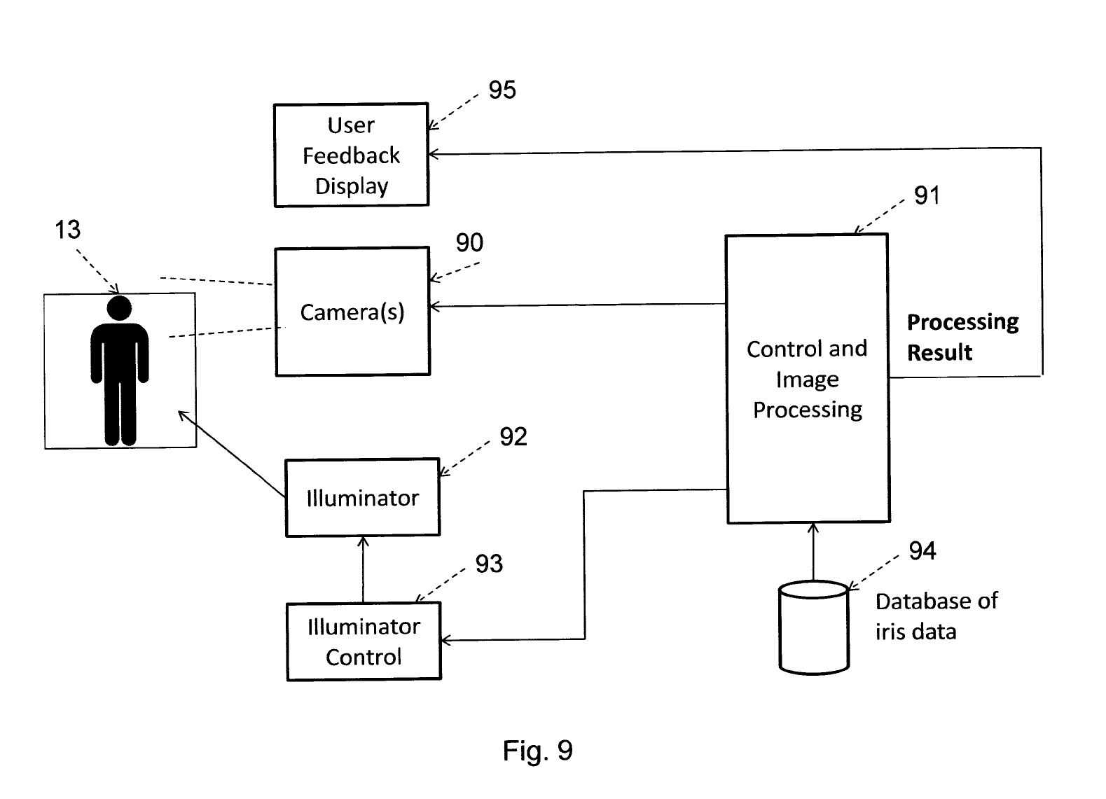

FIG. 6 shows a perspective view of the embodiment for a wall-mounted device, and FIG. 7 shows a profile view. FIG. 8 shows a perspective view of a similar embodiment, except the device is mounted on a counter-top. FIG. 9 shows a block diagram of the system modules. The Camera module(s) 90 feed into a Control and Image Processing Module 91 that acquires images of the user 13 and performs iris image acquisition and matching, by comparing iris data acquired from the user with iris data stored in a Database 94. An Illuminator Control Module 93 drives the Illuminator Module 92 on request from the Control and Image Processing Module 91, so that the eye is sufficiently illuminated so that high-quality images can be acquired. A User Feedback Display 95 controlled by the Control and Image Processing Module 91 displays the result of the iris matching process to the user.

A third aspect of the first embodiment maximizes the volume of the device to accommodate the required components shown in the block diagram of FIG. 9, while allowing the device to be mounted in very compact locations. This third aspect takes advantage of the constraint that vertical space in desktop, kiosk or wall-mount environments is less-utilized than horizontal space. For example, in the space between a doorway and an adjacent wall oriented perpendicular to the door, there is typically very limited horizontal space but substantial vertical space from the ceiling to the floor. We take advantage of this constraint by configuring the system such that the width of the system is small in order to fit into the limited horizontal space that is typically available, but such that the height of the system is substantially larger than the width of the system, thereby allowing the overall volume of the device to be sufficient to contain the modules described in FIG. 9. A preferred ratio of the height of the device to the width of the device is substantially 2 to 1, as indicated in FIGS. 6 and 8.

A fourth aspect of the first embodiment is that a mechanism on the pivot 11 maintains the tilt angle of the device chosen by the previous user. A wide range of users have similar heights and therefore require the same height adjustment. Therefore most users do not need to adjust the tilt mechanism at all, since there is a high probability that the previous user had already set the device to the same height setting. This is in contrast to a tilt mechanism that always points to a low or high tilt angle after usage. In one embodiment, the tilt angle used by the previous user is maintained using a ratchet and spring mechanism, so that the spring counterbalances the weight of the device and the ratchet prevents slipping of the device to a different tilt location.

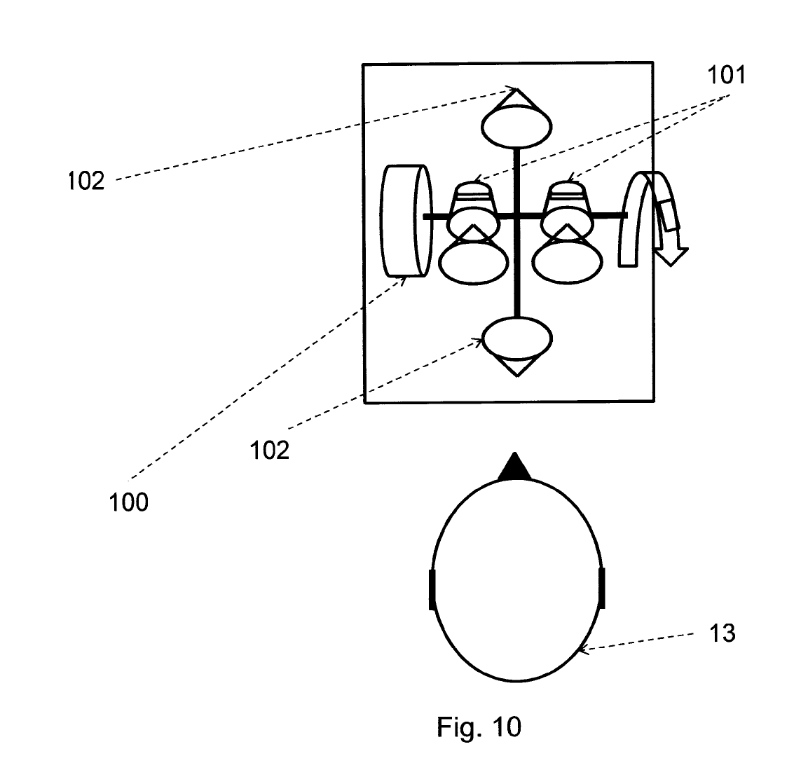

In some cases it is advantageous to avoid having the user adjust the tilt orientation of the device to minimize further the interaction of the user with the device. FIG. 10 shows this second embodiment of the invention. A camera module 101 and illuminator module 102 is located on a horizontal shaft that rotates by a position-controlled motor 100 within a housing of any type, including horizontally-oriented, cylindrical or oval-shaped, semi or fully transparent housings. Optionally, the illuminator modules may be fixed such that the only the camera module rotates. Also optionally, the camera module may be fixed but may be directed towards a mirror that is attached to the rotating shaft.

This approach of using only one degree of rotational freedom is in contrast to the pan and tilt mechanisms described by Chmielewski in U.S. Pat. No. 5,717,512 and Van Sant in U.S. Pat. No. 6,320,610. Any moving mechanism, be it pan or tilt or both, has a latency in time between the time that the position of the object where it is desired to point the pan and/or tilt mechanism is recovered, and the time that the actual pan and/or tilt mechanism can physically move to a location and provide a stable image. This latency is due to two factors: first, there is the time required to acquire and process the sensing data (for an example, a wide field of view imager connected to a processor in the case of Van Sant in U.S. Pat. No. 6,320,610), and second there is the time required to move the mechanical assembly and to allow the mechanical assembly to stabilize so that a high quality image of the subject is acquired. These two time periods can add up to a substantial fraction of a second, which means that if a user moves faster than this cumulative time period in an unpredictable fashion, then the pan/tilt mechanism will be unable to keep up with the user motion and imagery of the user cannot be acquired.

We resolve this problem by removing the pan mechanism, and by ensuring that there is sufficient horizontal field of view coverage of the cameras to accommodate the horizontal component of unpredictable user motion. We then use the tilt mechanism to accommodate the vertical component of unpredictable user motion. This provides a great improvement in performance over pan/tilt systems since we have found that the horizontal component of unpredictable motion of the user is substantially larger than the vertical component, due to the fact that subjects naturally and easily move from side to side with minimal expenditure of energy but subjects do not naturally nor easily change their height vertically. The result is a system that operates much more effectively than a pan/tilt system, and typically at a lower cost and with higher reliability, since there are less mechanical components and although there may be more camera sensors to ensure sufficient horizontal coverage, such sensors are relatively cheap and reliable. We compute the required horizontal coverage H of the cameras by estimating the required horizontal coverage S if the user were stationary, the magnitude of the horizontal component Ux of the unpredictable motion of the subject, and the temporal latency T in image acquisition, processing and mechanical movement described above. The required horizontal coverage is then governed by the sum of the required coverage S when stationary and the required coverage to accommodate unpredictable horizontal user motion, which is Ux.T. The required coverage is then H=S+Ux.T. A typical value of S is approximately 10 cm, so that the width of the face is covered, a typical value of Ux is 20 cm/sec, and a typical value of T is 0.25 second. The required horizontal coverage in this case is then H=10+20×0.25=15 cm.

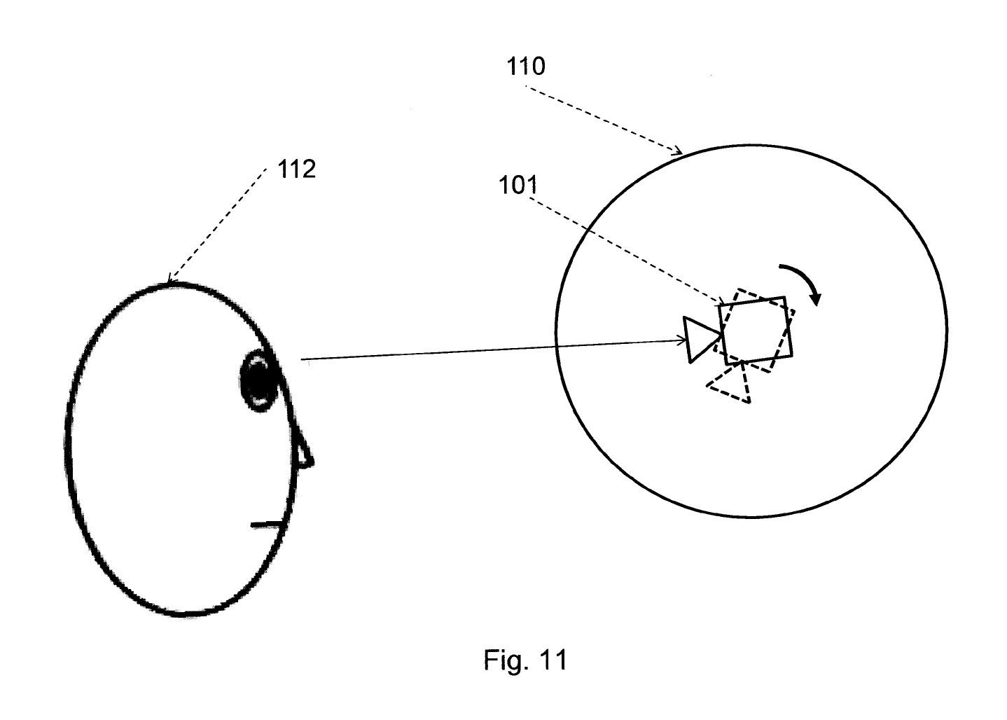

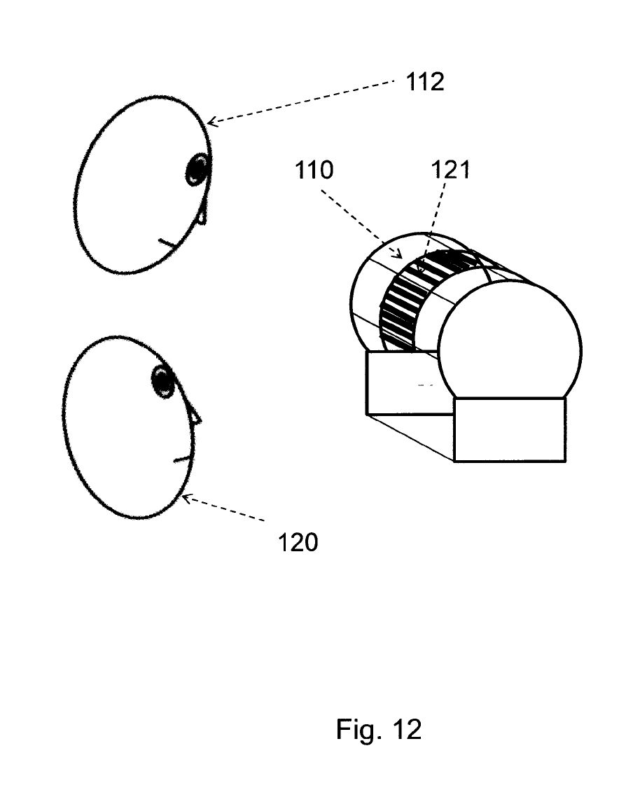

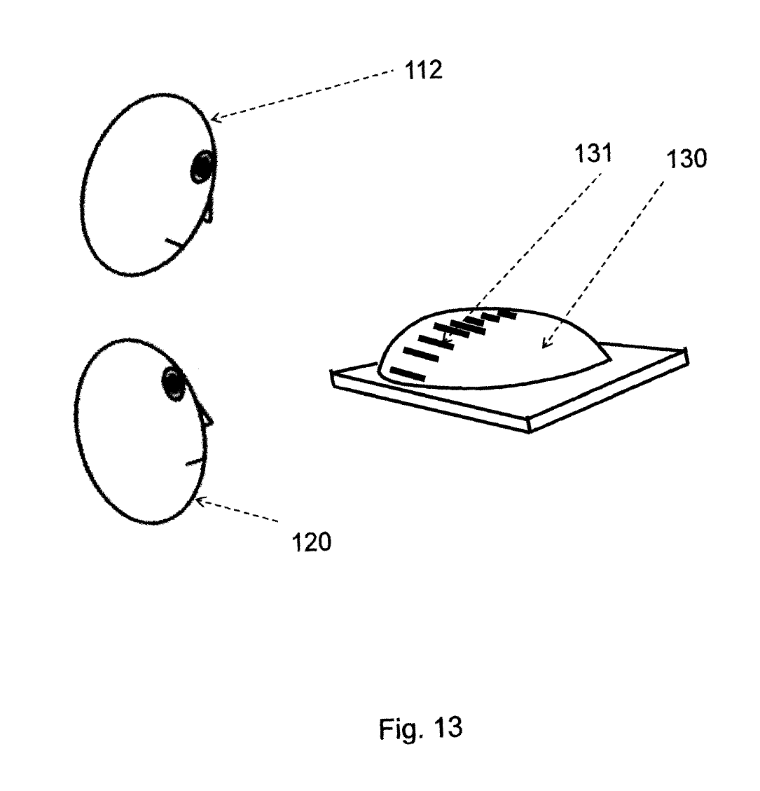

FIG. 11 shows a profile view of the second embodiment, showing the tilting of the camera module 101. It also shows an outer case 110 that is substantially rotationally symmetric shape about the axis of rotation. FIGS. 12 and 13 show perspective views of the embodiment using a cylindrical and oval shape for the outer housing respectively. One advantage of the substantially horizontally-oriented, cylindrical or oval shape is that the sense of orientation of the device is exaggerated, thereby making it intuitive for the user to stand perpendicular to the device, even when the size of the device is small with respect to the size of the user. This can be contrasted to a dome-shaped housing whereby from the shape alone, it is not intuitive for the user to stand in any particular direction with respect to the device. It is preferred that there is symmetry of the shape and appearance of the device about a vertical axis substantially through the center of the device in order to enhance the sense of orientation of the device.

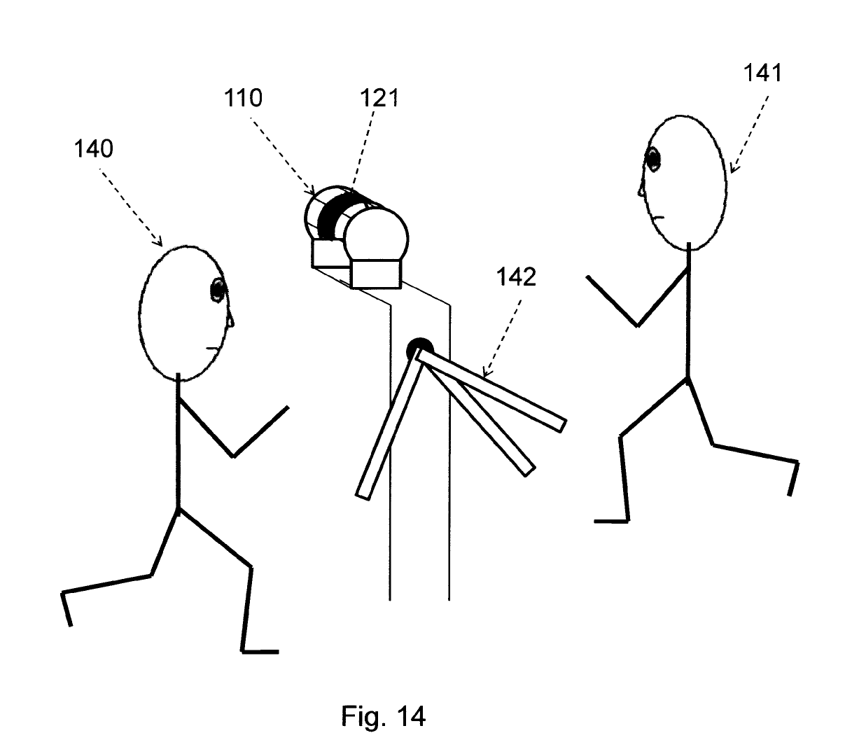

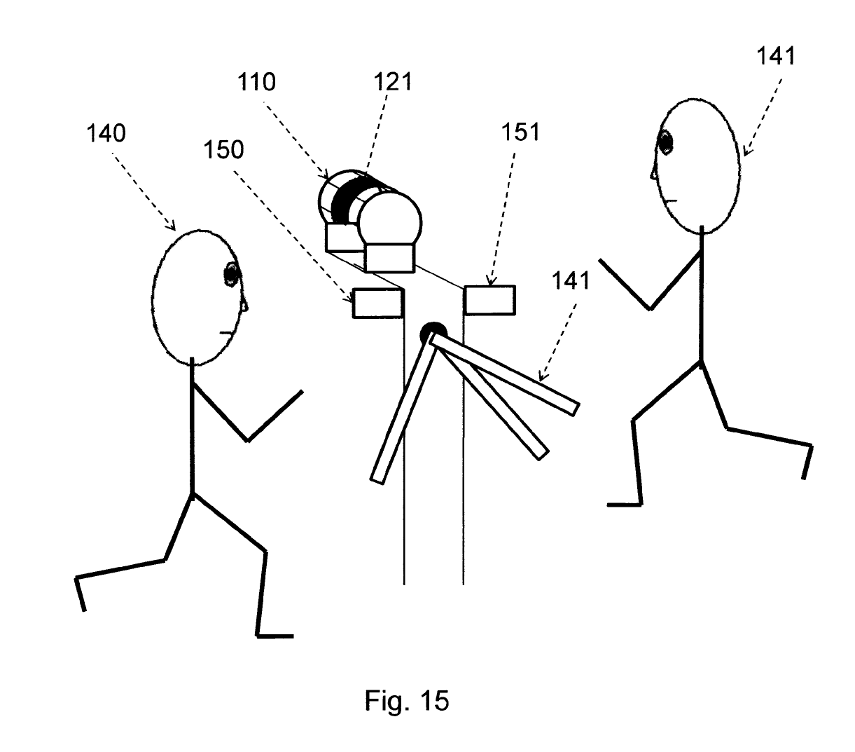

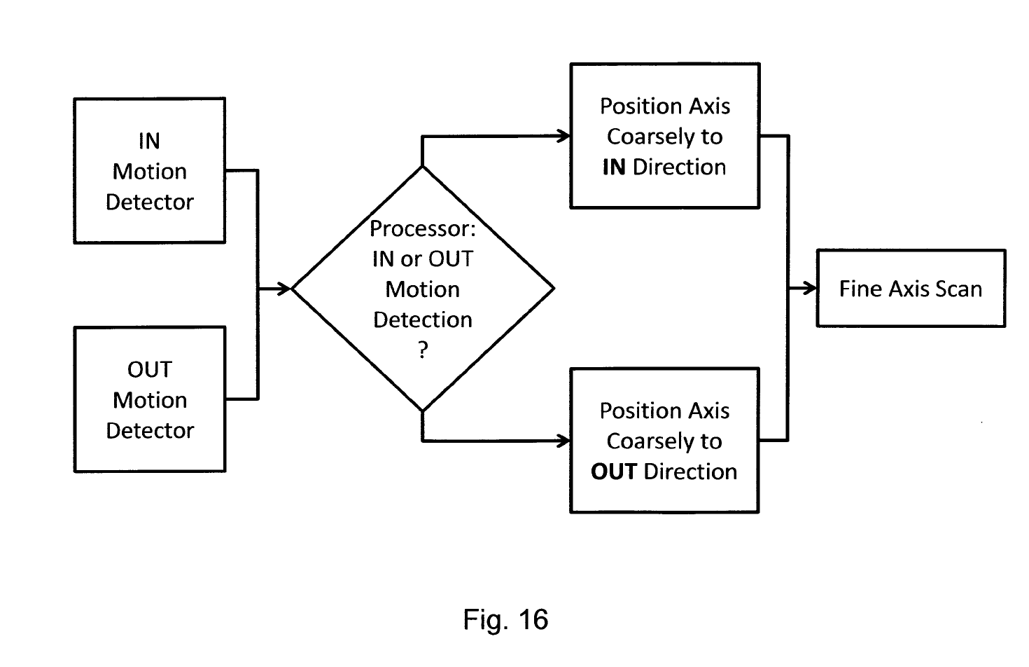

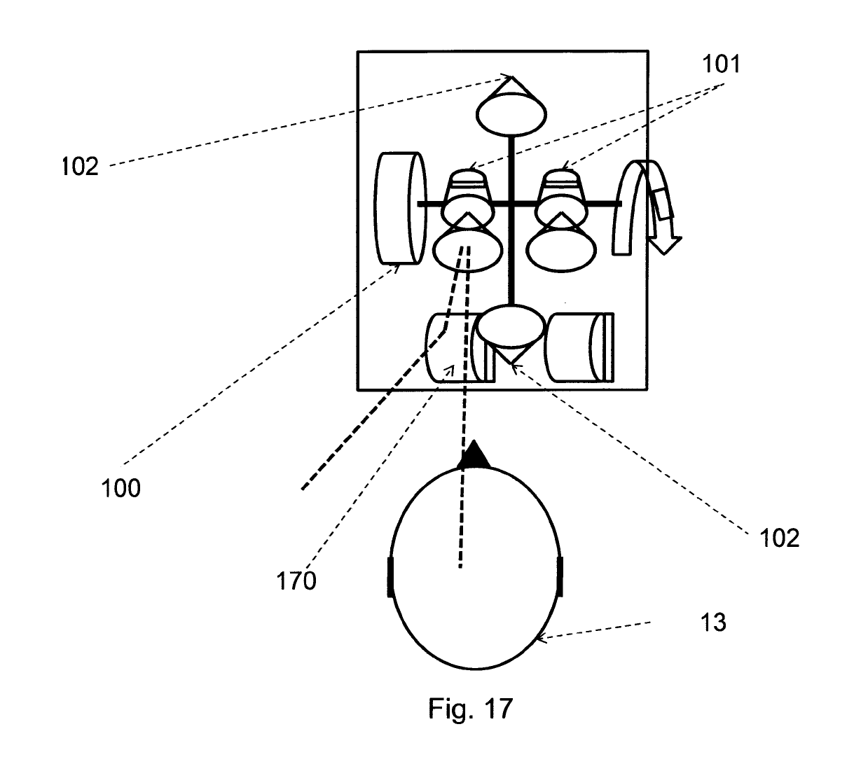

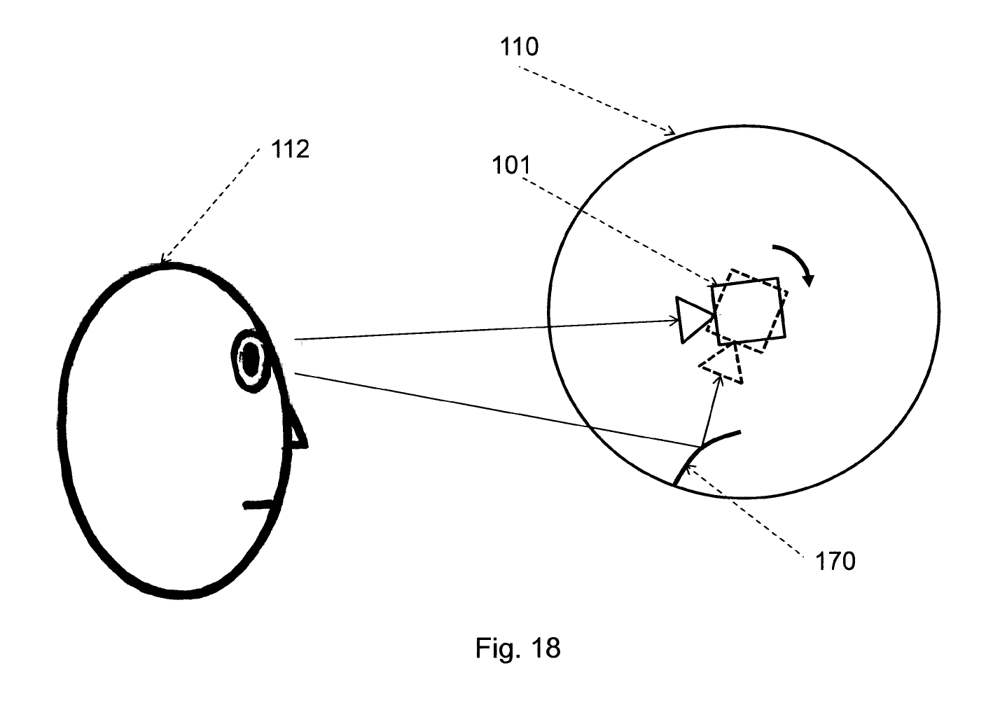

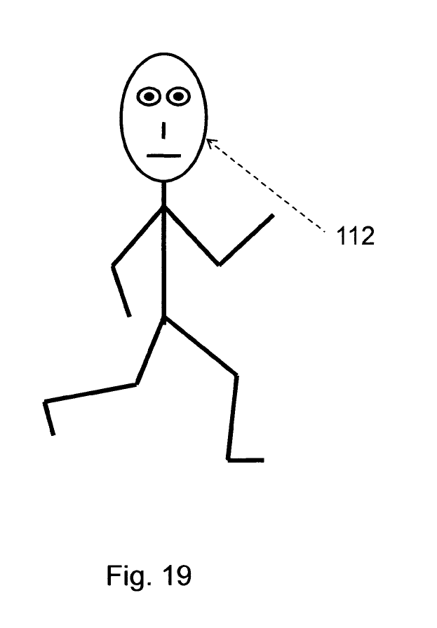

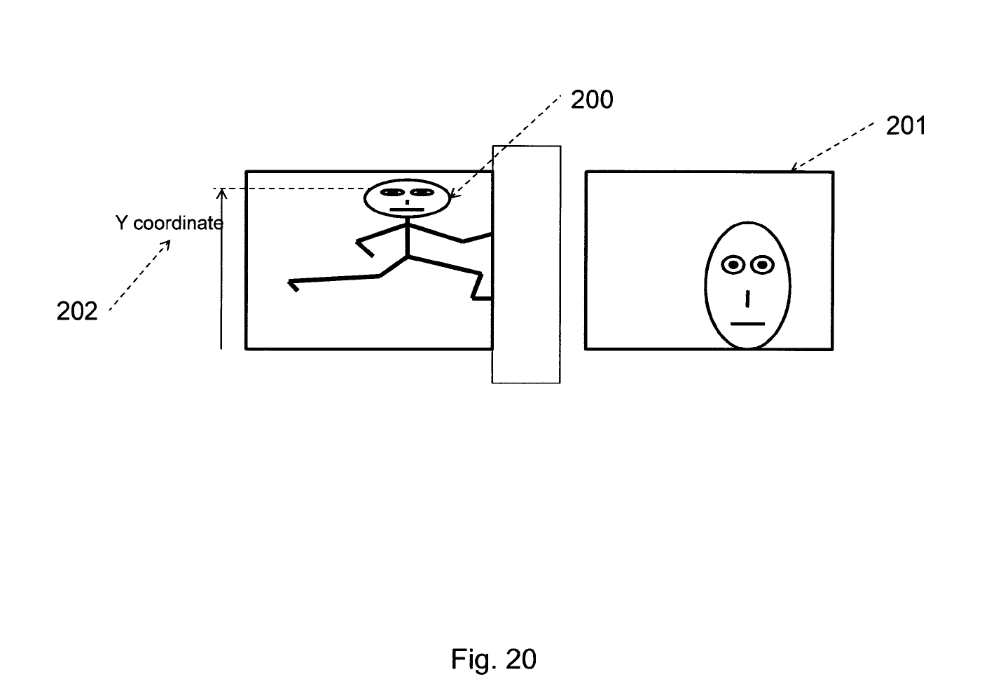

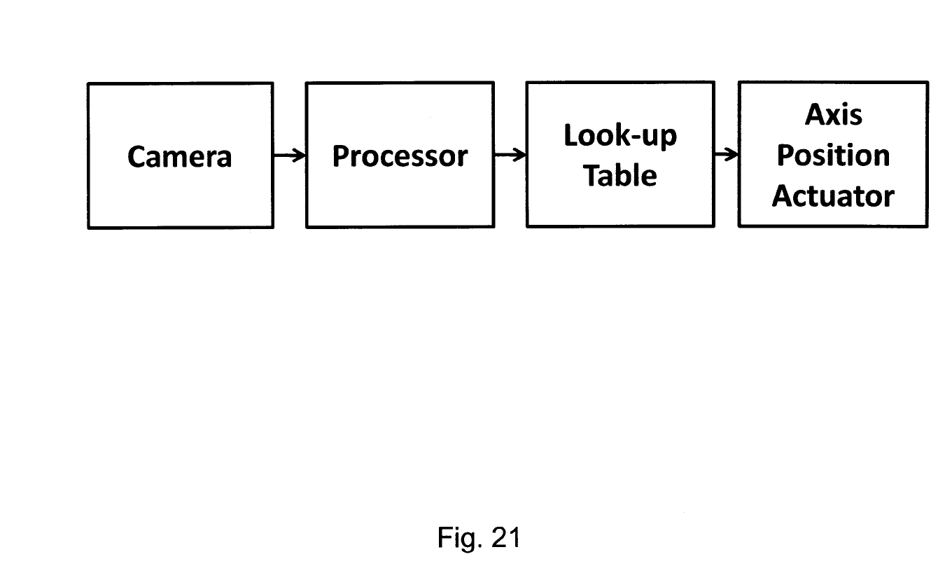

A further advantage of this embodiment is shown in FIG. 14. As in the first hand-actuated embodiment, it is possible for the same cameras and illuminators to be used to capture biometric data from both arriving users 140 and departing users 141 in particular configurations, for example at a turnstile 142. The shaft is designed to rotate at least 90 and preferably 120 degrees or more to ensure that data from both directions can be acquired. This reduces cost and size of an overall access control solution by requiring the deployment of only 1 device rather than 2 devices which would otherwise have to be deployed separately for each of the arriving and departing users respectively. Optionally, the rotational shaft can be supported at one end only, or in the middle of the shaft, as opposed to each end of the shaft, in order to reduce cost by minimizing the number of components required. In one embodiment shown in FIGS. 15 and 16, the biometric data is acquired by the first step of detecting the presence of a user on one or other side of the device by a presence or motion detector 150, 151, focused on either side of the device, and the second step of an automatic rotational sweep of the camera and illuminator module about the horizontal axis within the housing such that one or more eyes of the user is acquired during the rotational sweep. FIG. 16 shows how the presence of the person causes the camera to point coarsely in the IN or OUT direction, after which a scan is performed in order to locate the eyes. Many methods are known for eye finding. For example, the circular shape of the iris/sclera boundary can be located using the Hough transform feature detector as disclosed in U.S. Pat. No. 3,069,654. In one embodiment for eye-finding, one or more mirrors 170 that are substantially convex about at least one axis in a horizontal direction are mounted such that one or more cameras 101 point at it when the cameras are positioned at a particular orientation within the housing, as illustrated in FIGS. 17 and 18. As illustrated in FIGS. 19,20 and 21, during an eye-finding process, the cameras 101 are directed at the mirrors 170 to view the person 112 shown in FIG. 19. As shown in FIG. 20 on the left, since the mirrors are convex in at least 1 direction, the cameras observe a large view of the scene 200 in at least the vertical direction. If the mirrors are convex in only one direction and substantially flat or concave in the orthogonal direction, then in the orthogonal direction the cameras observe the same or smaller coverage than they would otherwise cover if the mirrors were not present. At least the vertical spatial coordinates 202 of the eyes with respect to the camera are located from the views observed by reflection off the mirror(s). This coordinate is fed into a look-up table that has been pre-calibrated with at least a rotation value for the axis around which the camera is rotated. In this way the camera can be rotated to point directly at the vertical position of the eyes and then acquire the image 201 shown in FIG. 20 on the right. This process is illustrated step-by-step in FIG. 21.

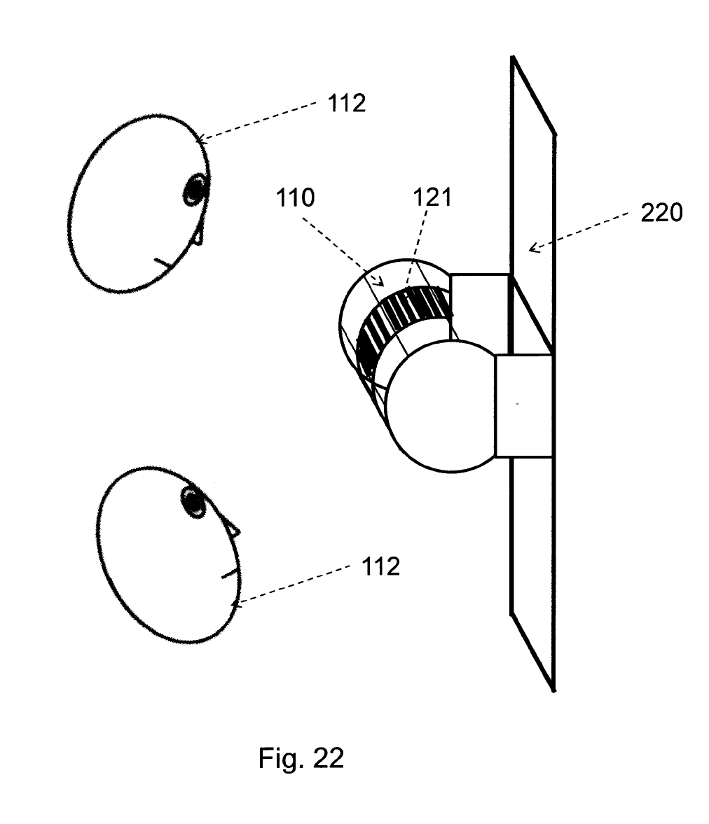

An additional advantage of the cylindrical or oval embodiment is shown in FIG. 22. The symmetry of the device around the horizontal axis means that the device substantially looks the same regardless of the height of the user 112 with respect to the device. This means that as the user encounters multiple devices deployed in different locations at different heights for varying applications (for example waist-height in some turnstile deployments or head height or higher in portal applications), then the device has substantially the same appearance. This is significant since it is much easier for the user to transfer their experience of operation in one scenario with operation in another very different scenario, thereby improving their ability to successfully use the device. In addition, since the appearance of the device is the same to young children, wheelchair users as well as to tall users, the instructions that may be provided for device usage are uniform and less prone to error in interpretation.

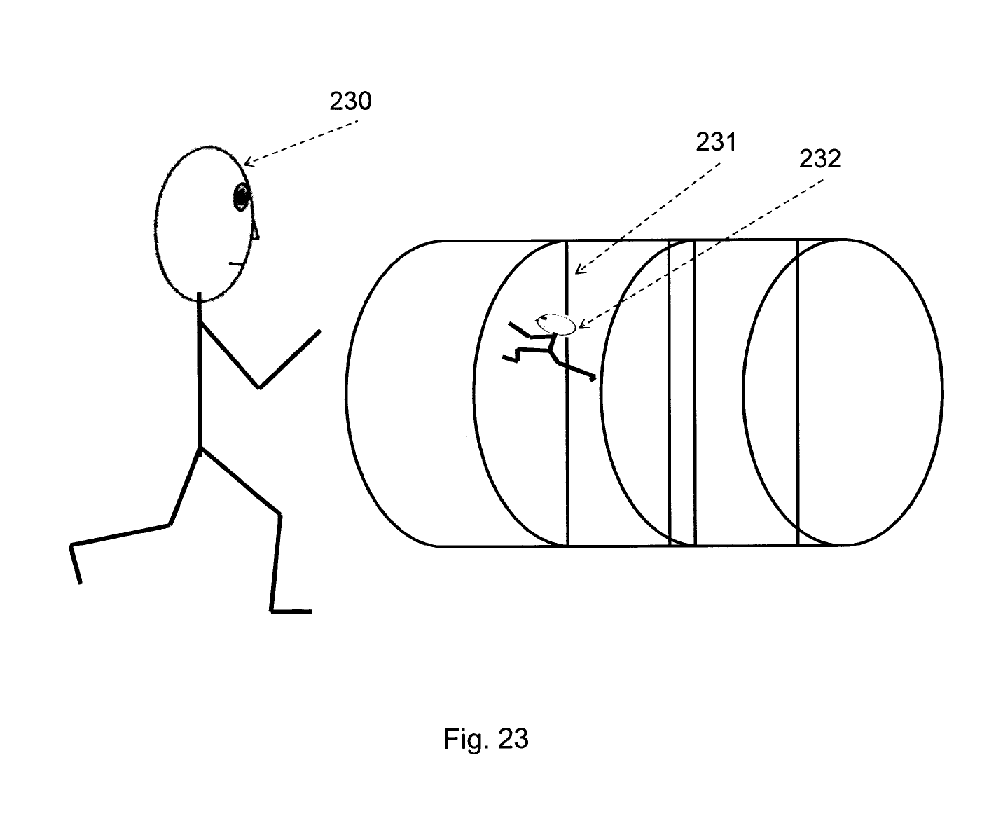

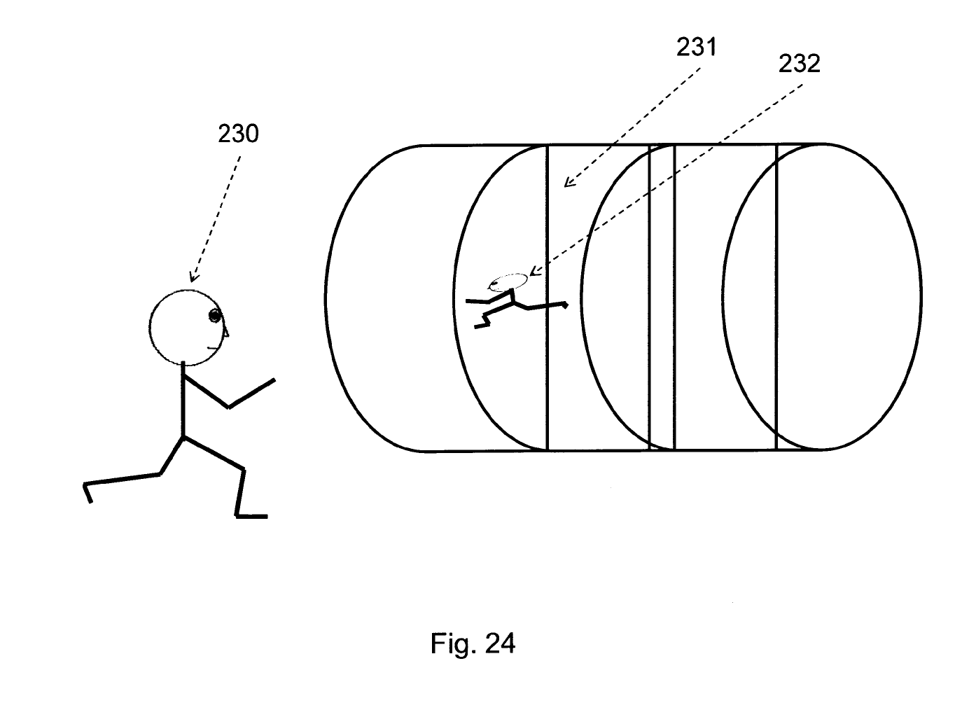

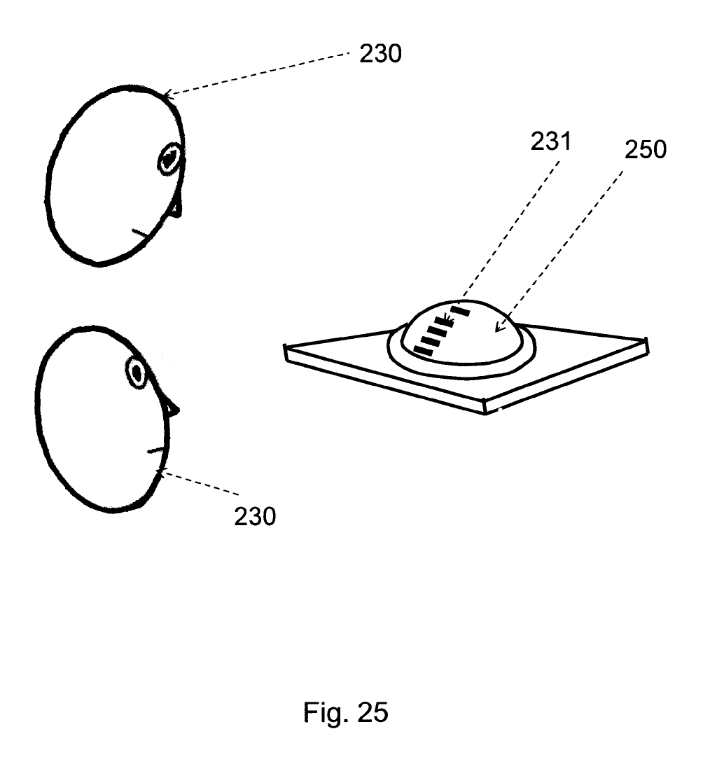

A further embodiment is shown in FIGS. 23 and 24. We enhance the intuition of the user 230 to position themselves substantially in front and perpendicular to the device using a reflective component 231. In a first application of this further embodiment, we use a wholly or partially reflective, convex curved surface 231 (convex in one direction only along a horizontal axis) on the central portion of the device. As shown in FIG. 25, note that the requirement for the device to be cylindrical or oval-shaped can optionally be modified such that the device can also be substantially dome-shaped 250, since the highly vertically oriented reflective central portion 231 takes over from the cylindrical or oval shape as the cue to guide the user 230 to stand in front of the device substantially perpendicular to the center of the device. In this case, then we only require substantial symmetry of the shape of the device about a horizontal axis, which is consistent with a substantially cylindrical, oval or dome-shaped device. As shown in FIGS. 23 and 24, regardless of the height of the user 230, as the user moves to position themselves generally in front of the device, the reflection 232 of the user in the mirror is an indication that naturally causes them to pause and maintain position close to that point, as opposed to any other point where their reflection cannot be observed. The ability to obtain a large-sized reflection 232 of a user 230 at a wide range of heights as shown in FIGS. 23 and 24 is an important capability. This is to be contrasted with existing approaches whereby a small flat mirror is used as a guide for the user to center themselves as described by Chae et. al U.S. Pat. No. 6,652,099, or a small rotationally symmetric concave mirror as described by McHugh U.S. Pat. No. 6,289,113. In these cases the user already has to either be at the correct height or has to adjust the device to the correct height in order to observe their reflection. Approaches that use such small, flat or rotationally-symmetric mirrors are therefore are only useful for relatively small self-adjustments. One special advantage of a mirror that is convex substantially in one direction only is that the magnification of the mirror is unity in one direction, as shown below, so that the overall size of the observed image 232 of the user in FIGS. 23 and 24 remains large, and therefore visible from a distance by the user. This is to be contrasted with a mirror that is convex and rotationally symmetric since in order to ensure that the user at any height will still remain in the range of the reflective area of the mirror so that the user will be able to see their reflectance, then the radius of curvature required and therefore the resulting magnification will lead to a very small observed image of the user that will be much smaller when observed from a distance by the user, and therefore more difficult to use as a guidance mechanism.

The reflection equations governing the curved reflective surface are: F=−R/2, where F is the focal length in the direction perpendicular to the radius of curvature R of the convex mirror. The lens equations are:

1/Do+1/Di=1/F, where Do is the distance from the center of the radius of curvature of the lens to the user, and Di is the distance from the center of the radius of curvature of the lens to the virtual image of the user being reflected off the convex surface. Magnification M is defined by: M=−Di/Do

In the horizontal direction the magnification of the user is 1.0 since R=infinity in that direction. The preferred horizontal width of the mirror is such that an image of width of at least ½ the separation of the expected eye separation is observed. The average eye separation is 2.5″. Since M=1 in this direction, then the preferred mirror width is at least 1.25″.

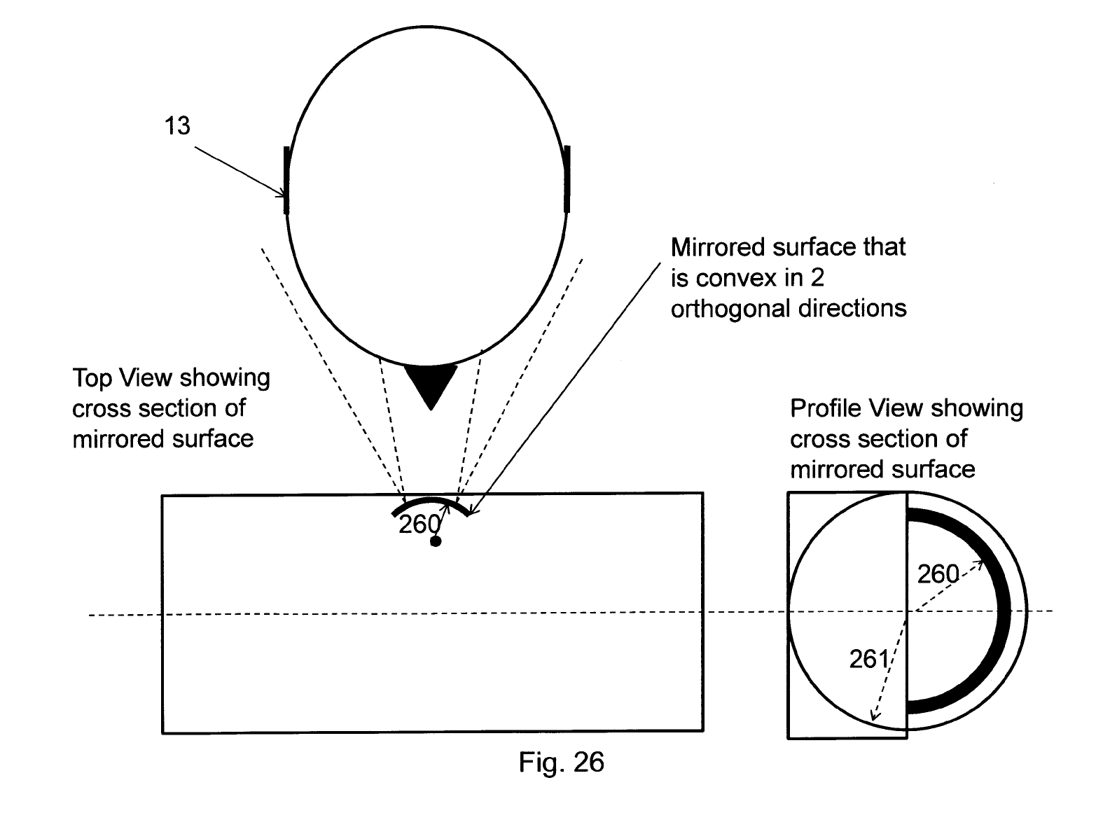

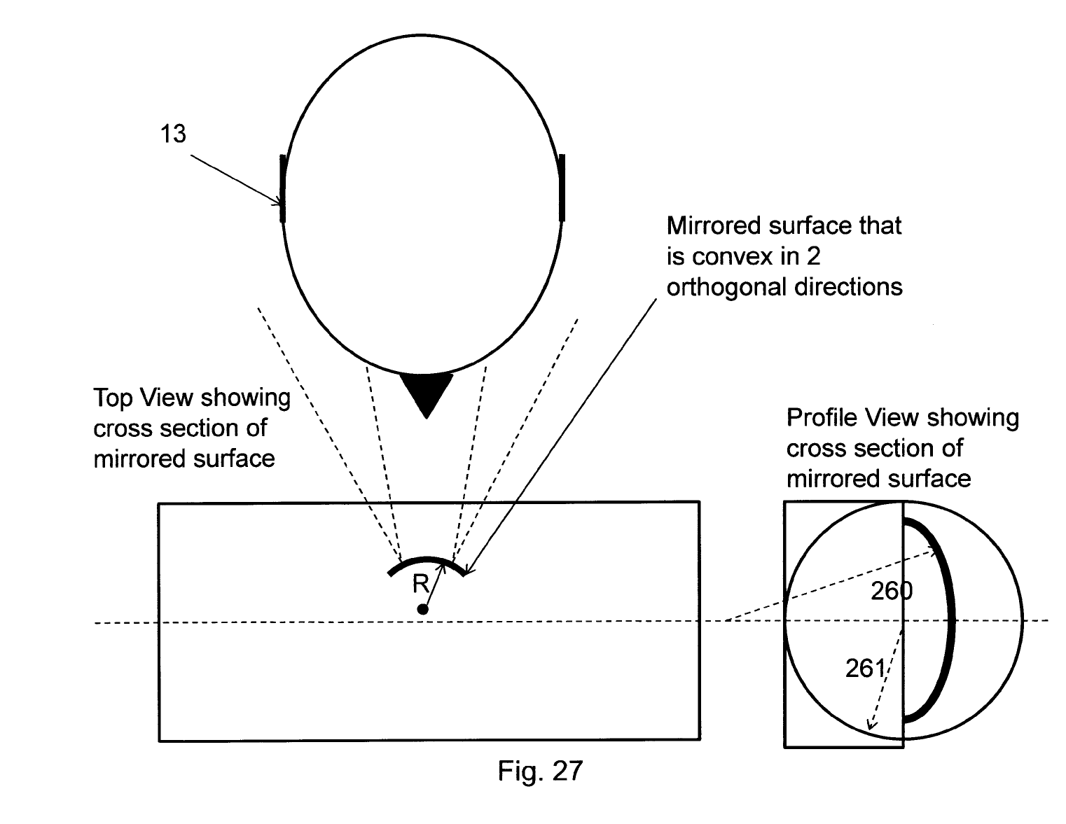

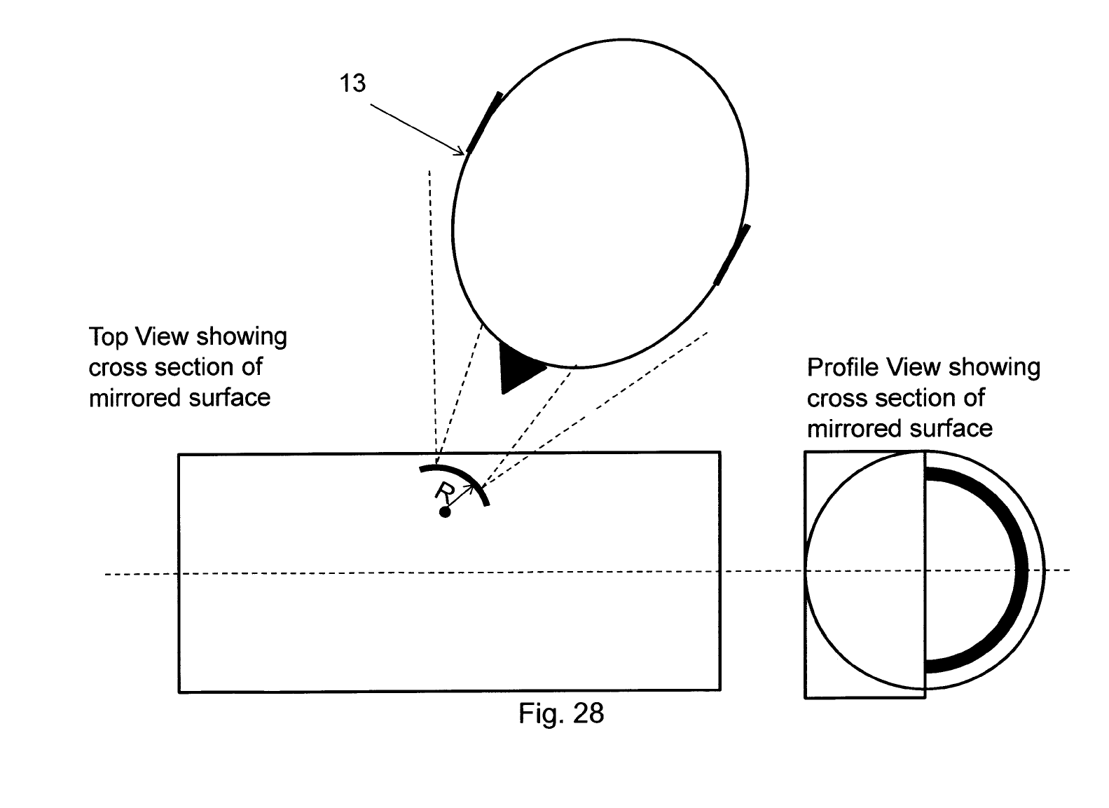

If we consider the case of a particular curved, horizontally-positioned cylinder, then with R=0.1 m along the axis of the cylinder and R=infinity along the orthogonal axis, then M (the magnification) in the vertical direction of a user 1 meter away (Do=1 m) is 0.0476. This means that the image that the user observes is compressed 1/0.0476 (or about 20) times in a vertical direction. Since the motion of the reflection of the user is often sufficient to make them pause at the correct location, the appearance of a vertically-compressed image is often not a problem. However, a further embodiment of the invention resolves the vertical compression by using a partially or wholly reflective surface that is convex in both directions, as shown in FIG. 26. In order to achieve a reflected image that has the same magnification in both the vertical and horizontal direction, then the radii of curvature of the mirrored surface about the horizontal axis and the orthogonal axis are chosen to be substantially the same. The radius of curvature 260 of the mirror is chosen to be substantially equal to the radius of curvature 261 of the outer surface, but in one embodiment, the radii of curvature can be larger than the radii of the outer surface by placing the mirrored surface to be at a varying distance from the outer surface as shown in FIG. 27, such that the radius of curvature 260 of the mirror is substantially larger than the radius of curvature of the housing 261. This can increase the radii of curvature of the mirror by a factor of 2 over the radii of the outer housing. The benefit of this is that the magnification of the observed image is also increased by a factor of 2. Note that in a further embodiment, there are some applications (such as a bi-directional turnstile application) whereby the device is situated to one side of the user, and therefore the cameras and illuminators are not directed perpendicular to the surface of the outer housing but are instead directed to one side, as illustrated in FIG. 28. In this case, the curved reflected surface is either partially covered or otherwise configured to only show a reflection to one side of the device corresponding to the angle of the cameras. This allows correct intuitive centering even though the user is slightly off-axis with the device.

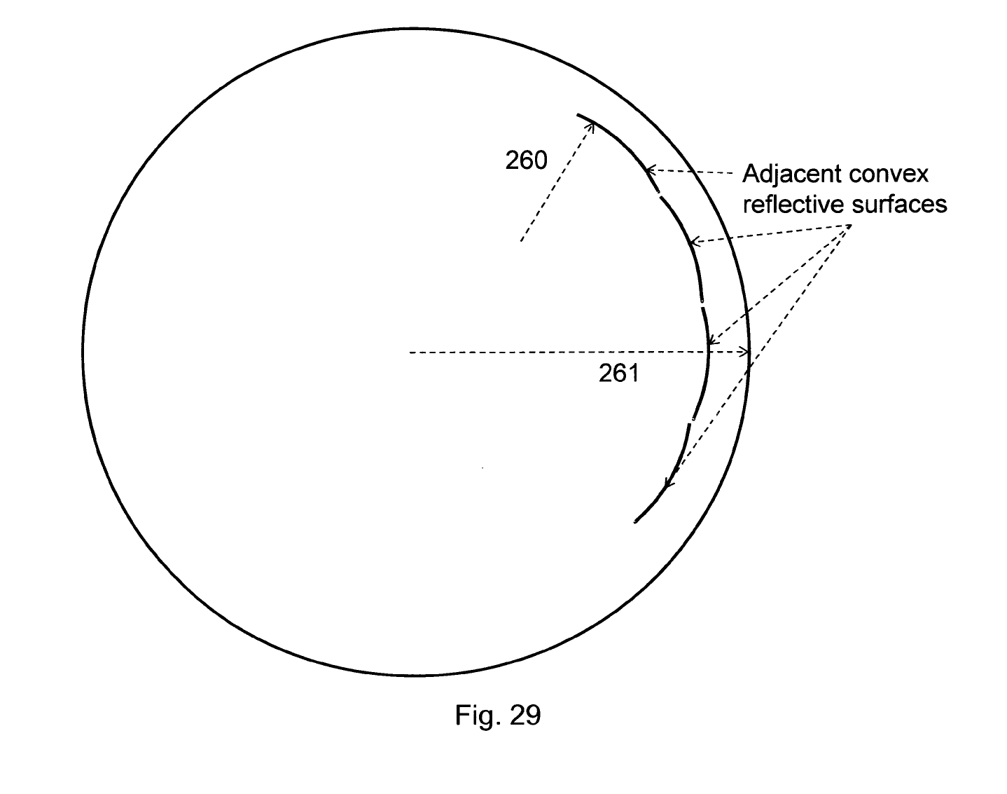

In a further embodiment, rather than using a continuous reflective surface, a set of piecewise-convex reflective surfaces are arranged to be adjacent to each other on a curved surface, as illustrated in FIG. 29. The radius of curvature of the outer housing 261 can be configured to be substantially larger than the radius of curvature 260 of each of the adjacent reflective lens. In some applications, this can result in a more cost-effective solution. This approach is to be contrasted with the placement of a single convex mirror on the flat surface of a mobile phone, for example, whereby the user is only observed when the phone is pointed in the first place in approximately the correct orientation.

While the invention has been described an illustrated in detail herein, various alternatives and modifications should become apparent to those skilled in this art without departing from the spirit and scope of the invention.

What is claimed is:

1. A biometric iris recognition device, comprising:
a primary housing pivotably attached to a base about a substantially horizontal axis;
a first camera and a first illuminator module both disposed in said primary housing and oriented to face a front of said primary housing; and
at least one handle, extending from and disposed off-center on an exterior of said primary housing, adapted to allow a user to pivot said primary housing about said substantially horizontal axis to align said first camera and said first illuminator module with the user's eye.

2. A biometric iris recognition device according to claim 1, further comprising a hinge formed between said primary housing and said base as said pivotable attachment, wherein said hinge allows said primary housing to rotate solely about said substantially horizontal axis.

3. A biometric iris recognition device according to claim 1, wherein said handle is disposed on a side portion of said primary housing substantially orthogonal to said front of said primary housing.

4. A biometric iris recognition device according to claim 3, wherein at least one said handle is offset from substantially horizontal axis.

5. A biometric iris recognition device according to claim 1, wherein said primary housing can rotate more than 90 degrees with respect to said base.

6. A biometric iris recognition device according to claim 1, wherein said primary housing further comprises a second camera and a second illuminator module, wherein said first camera and illuminator module face in a first direction, and said second camera and illuminator module face in a substantially opposite rear direction.

7. A biometric iris recognition device according to claim 1, wherein a height to width ratio of the overall device is substantially 2 to 1.

8. A biometric iris recognition device according to claim 1, wherein a height to width ratio of said primary housing is substantially 2 to 1.

9. A biometric iris recognition device according to claim 1, further comprising at least one positioning mirror disposed on said front of said primary housing, adapted to reflect the image of a user back to the user when the user's face is substantially aligned with the optical axis of said camera.

10. A biometric iris recognition device according to claim 9, wherein said positioning mirror is convex in primarily one direction only.

11. A biometric iris recognition device according to claim 6, further comprising:
at least one first positioning mirror disposed on said front of said primary housing, adapted to reflect the image of a user back to the user when the user's face is substantially aligned with the optical axis of said first camera; and
at least one second positioning mirror disposed on said rear of said primary housing, adapted to reflect the image of a user back to the user when the user's face is substantially aligned with the optical axis of said second camera.

12. A biometric iris recognition device according to claim 11, wherein said first and second positioning mirrors are convex in primarily one direction only.

13. A biometric iris recognition device according to claim 10, wherein said positioning mirror includes an at least partially reflective surface that is convex about a substantially horizontal axis and substantially flat about a substantially vertical axis.

14. A biometric iris recognition device according to claim 12, wherein said first and second positioning mirrors each includes an at least partially reflective surface that is convex about a substantially horizontal axis and substantially flat about a substantially vertical axis.

15. A biometric iris recognition device according to claim 1, wherein said first camera includes a wide angle field of view in a substantially horizontal direction.

16. A biometric iris recognition device according to claim 6, wherein said first and second cameras each includes a wide angle field of view in a substantially horizontal direction.

17. A biometric iris recognition device, comprising:
a first camera and a first illuminator module both disposed in a primary housing and oriented to face a front of said primary housing; and
at least one first positioning mirror, disposed on said front of said primary housing, adapted to reflect the image of a user back to the user when the user's face is substantially aligned with the optical axis of said first camera, wherein said positioning mirror is convex in primarily one direction only.

18. A biometric iris recognition device according to claim 17, said primary housing being pivotably attached to a base about a substantially horizontal axis.

19. A biometric iris recognition device according to claim 17, wherein said primary housing further comprises a second camera and a second illuminator module, wherein said first camera and illuminator module face in a first direction, and said second camera and illuminator module face in a substantially opposite rear direction.

20. A biometric iris recognition device according to claim 19, further comprising at least one second positioning mirror disposed on said rear of said primary housing, adapted to reflect the image of a user back to the user when the user's face is substantially aligned with the optical axis of said second camera, wherein said second positioning mirror is convex in primarily one direction only.

21. A biometric iris recognition device according to claim 17, wherein said first positioning mirror includes an at least partially reflective surface that is convex about a substantially horizontal axis and substantially flat about a substantially vertical axis.

22. A biometric iris recognition device according to claim 20, wherein said first and second positioning mirrors each includes an at least partially reflective surface that is convex about a substantially horizontal axis and substantially flat about a substantially vertical axis.

23. A biometric iris recognition device according to claim 17, wherein said first positioning mirror is an integral reflective portion of said primary housing.

24. A biometric iris recognition device according to claim 23, wherein said reflective portion of said primary housing comprises one of a cylindrical, oval, or dome-like shape.

25. A biometric iris recognition device according to claim 20, wherein said first and second positioning mirrors are integral reflective portions of said primary housing.

26. A biometric iris recognition device according to claim 24, wherein said reflective portions of said primary housing comprise one of a cylindrical, oval, or dome-like shape.

27. A biometric iris recognition device according to claim 17, said camera being rotatably mounted in said primary housing about a substantially horizontal axis.

28. A biometric iris recognition device, comprising:
a primary housing attached to a base by means of a pivot that can only rotate solely about a substantially horizontal axis;
an illuminator module disposed in one of said primary housing or said base;
a first camera module disposed in said primary housing and oriented to face a front of said primary housing, said first camera including a wide angle field of view in a substantially horizontal direction; and
automatic positioning means for pivotably positioning said primary housing about said substantially horizontal axis to automatically align an optical axis of said first camera with a face of a user.

29. A biometric iris recognition device according to claim 28, said first camera further comprising a field-widening mirror optically interposed between said first camera and a user, said field-widening mirror being convex in a substantially horizontal direction and substantially flat in a substantially vertical direction.

30. A biometric iris recognition device according to claim 2, said hinge further comprising a position retaining mechanism, wherein when a user sets an angular position of said primary housing with respect to said base, said angular position remains until another user affirmatively adjusts said angular position.
